(19) United States
(12) Patent Application Publication
(10) Pub. No.: US 2015/0019315 A1
(43) Pub. Date: Jan. 15, 2015

(54) COMMUNITY INCENTIVIZED EXCHANGE FOR MONETIZING SOCIAL MEDIA AND CONSUMER-DRIVEN ADVERTISEMENT

(71) Applicants: Peter Swanson, Dallas, TX (US); Caroline Austin, Dallas, TX (US)

(72) Inventors: Peter Swanson, Dallas, TX (US); Caroline Austin, Dallas, TX (US)

(21) Appl. No.: 13/942,513

(22) Filed: Jul. 15, 2013

(51) Int. Cl. G06Q 50/00; G06Q 30/06; G06Q 30/02

(52) U.S. Cl. CPC G06Q 50/01; G06Q 30/0223; G06Q 30/0605
USPC 705/14.24; 705/26.2

(57) ABSTRACT

The present invention relates to affinity transactions devices, systems, and methods, including a community-incentivize exchange (CIE) comprising one or more computer systems configured to permit aggregation of purchasing power of social community members along aligned interests to facilitate purchases of desired nods or POS transactions from one or more vendors willing to exchange the nods or consummate POS transactions for consideration from the members and to return compensation to the social community in exchange for incentivizing the members to effect such purchases.

### FIELD OF THE INVENTION

The present invention relates to affinity transactions systems and methods.

### BACKGROUND

Monetizing the full value of social media networks has, to date, been an elusive task even for the most successful businesses. Reasons for this include the lack of a transactional nexus to identify sales conversions, inefficiencies in aligning economic goals of all parties in a dynamic environment where people flow from one interest to the next, and an inability to address informational asymmetries when the consumer is not actively involved early in the transaction process with feedback mechanisms.

Social media is a very powerful tool for aggregating individuals with similar interest, but thus far has largely been used in a post-hoc fashion. This means that social media generally can only track where individuals document their preferences. Consequently, advertising and marketing schemes that make use of social media focus or target only where people have already moved, and chances are by the time those campaigns are implemented, have moved from. In general terms, an “event” happens; the people move and the marketers follow (often only to find that the intended audience has already moved in response to the next “event”). Currently there does not exist a method for markets and marketers to know where individuals are going or to target individual preferences before they arise.

Of course, many advertisers attempt to create events (or proxies for events), in hope that people will move accordingly. Current advertisement schemes, such as banner ads, attempt to catch as many “eyeballs” or views as possible in the hope of catching viewers' interest. This technique is inefficient in the context of today's technology, as individuals' preferences are dynamic. Consequently, marketers are investing large sums of capital and resources in an attempt to figure out how best to reach a specific demographic audience and to determine what that audience wants.

### EXEMPLARY EMBODIMENT

Social media has the power to influence individuals' preferences, e.g., based on the communities the individuals interact with. Hence, involving these communities in the advertisement process may tend to increase targeting or, stated differently, create a target at the right time and the right place. The invention captures and monetizes this “social action” which is independent of the media individuals use to communicate their involvement and support of the community and the communities' preferences. The invention establishes a single, independent nexus that converts connections into sales, thereby allowing a direct and efficient market-based valuation of individuals' and communities' influence on each other by/through their ability to direct the movement of people and money. Through the establishment of such a nexus, the current lack of an efficient or accurate way to value a social network will be addressed; the strength of the ability to influence another person or a group is recognized as the value to the network. This method establishes a process and infrastructure to capture and engage individuals electronically. Changing the traditional model of “outward bound only” marketing tactics, this model leverages the power of individual social networks and collective communities to connect buyers and sellers. Involving the consumer (through affiliations) to identify the product offering and, in turn, using the consumer's own social networks to promote the products he/she already wants and when he/she wants them, this model results in high sales conversation rates.

This nexus is herein called a community-incentivized exchange (“CIE”). A CIE instantiates methods and systems for advertisement, customer acquisition, customer recidivism, and monetizing social media networks by merging economic principles with technology to realign spending patterns, while creating a competitive bid system for goods and services to serve the needs of communities. Through an active exchange of supply and demand information, combined with the ability of consumers to actively approach suppliers from whom they would like to purchase goods and/or services, the flow of information becomes less asymmetric than is currently the case. The result is a reduced customer acquisition cost for vendors while consumers reap the rewards of lower cost. Introducing the notion of community involvement and influence through social media connections, communities with specific demands are rewarded for aligning the spending patterns of their members in a specific direction. Ultimately this will increase revenues for vendors and provide goods and services to the community at lower prices.

Addressing some of the deficiencies of the state of the art, the CIE allows communities to identify preferences of their individual members while the community creates the event(s) for the group. The CIE also allows individuals to express preferences with a plurality of communities. By having the communities move in concert, by incentivizing the community members to influence their strong ties outside of the community as well, promotions can become more successful. As promotional activity begets new customers for vendors, these events are aligned with venders' goals obtaining customer acquisition at a lower cost and customer recidivism.

The CIE also aligns spending patterns through social media. This model can more directly connect consumers to goods and services, which they are already interested in buying. Additionally, the CIE gives direct access to the social networks to which advertisers (both for profit and non profit) currently do not have access in large numbers. Financially incentivizing “geographic and virtual communities” to use their networks for advocating goods and services, the model results in customer acquisition and transactional revenue to both the vendor and CIE provider. Thus, the CIE realizes the adaptability of social networks to identify individual and community preferences and proactively exploits this information through a defined process.

The present invention also encompasses community-incentivized retail (“CIR”). CIR identifies virtual and physical communities and establishes a computer-based nexus (e.g., the CIE) to monetize the collective purchasing power of the communities and their individual members, connecting them with vendors who wish to serve them. This exchange uses both incentives for communities and discounts for individuals as means for businesses to acquire customers and encourage recidivism. The customer may use any standard bank card, other electronic payment system, or cash where CIE has an agreement for data exchange and the customer releases the use of such data. This is termed the “point of sale” or “POS” method of payment. POS is used to physically move money between individuals and vendors. Additional money movement or payment systems may be implemented by CIE as technology and customer preference may dictate. Additionally, discounted store credits or “nods” as described below, may be used. By acquiring a discounted store credit or gift card, for example, an acquiring customer commits to becoming a customer at a particular place of business. Below we describe the purchase of “nods” at the exchange, which nods can later form the basis of retail transactions. These later retail transactions between the customer and the merchant concerning a particular item (or items) or service (or services) of the customer's choice (which may require the customer to select from a defined set of goods/services which the merchant is willing to exchange for the previously purchased credit) thus capitalizes on the group's purchasing power but retains a level of individual preference for the customer. Whether using “nods” POS methods, in effect, the customer still acts for individual gain, but in doing so also benefits his/her community. This is known as transaction flow CIR to emphasize its community-incentivized nature. CIR thus describes customer actions to purchase specific items at specific (presumably discounted) prices, while benefitting communities of which the customer is a part, combining current retail functions with several new functions.

Incentivizing communities to act on their members' shared demands creates aggregated purchasing power to negotiate in a computer-based nexus or exchange with multiple vendors. Incentivizing the community to identify its members' wants or needs and matching those members with vendors who wish to serve them aligns the economic interests of all parties. This process achieves an efficiency-enhancing integration of parties through a portal promoting a freer flow of information between providers of goods and services and consumers who wish to access them. The aforementioned process creates an optimum and efficient exchange promoting free enterprise.

In some instances the transactions offered through the exchange may be private in nature. For example, communities may wish to establish exclusive or semi-exclusive relationships with vendors so that only members of the community can benefit from negotiated deals. This serves three purposes. First, it may incent individuals to become members of the community (in order to take advantage of the deals). Second, it may shield vendors from having to offer similar discounts to others. Third, it protects members of a community, and the community itself, from having non-members arrive (uninvited) to events, etc.

Community-based sales and marketing engages the interest, purchasing power, and information within social networks to consummate commercial and eleemosynary transactions in an exchange while incentivizing communities to act for their own benefit. What was once a unidirectional flow of information now becomes a bi-directional flow, correcting informational asymmetry between potential buyers and sellers, and harmonizing both parties' goals and objectives. Communities, buying in concert, also have more purchasing power than an individual.

Unidirectional information is generally seen as advertising, where suppliers try to find and entice buyers, one individual at a time. For products for which there is community demand this is particularly inefficient. In a bi-directional system, such as that realized by the present methods and systems, buyers express interest in what they want through a “demand portal”, while vendors can advertise through a “supply portal”. Consumer driven advertisement and incentives are realized through payment for order/transaction flow back to the community (and/or vendor) at the completion of a transaction, and consummated in an exchange, thereby incentivizing the community (and/or vendor) to act. Consumers' advertise what they want, suppliers bid on the deals they wish consummate. Suppliers in this model make payments to communities only when consumers make purchases. Much of the cost of advertising becomes “performance based”, arising only when the consumer makes a purchase. CIE creates an electronic based “performance based advertising” structure.

Many times, communities plan events, and can therefore act in concert, in connection with or to satisfy a singular need of its members. Such is the case, for example, when a community plans a convention. However, using the present portal communities having members with various needs and preferences can post their interests and incentivize their members to buy when it benefits both the member and the community. This demand can be both “planned” and ad hoc. The present exchange is able to capture the ad hoc transaction equally as well as the planned transaction.

In one embodiment of the invention, a three-tiered exchange is made available. A first tier includes an informational portal, identifying “demand information”, i.e., the self-identified needs within the community, and relaying this information to vendors who wish to supply the needs by offering specific discounts as well as incentives to the community as a whole.

A second tier includes a competitive bid exchange where communities can request bids for more specific needs from multiple vendors.

A third tier includes a monetary exchange where the commitment of funds by individual consumers in exchange for goods or services takes place. This exchange can occur within the scope of the CIE, Point of Sale, or a third party transactional processor.

The three tiers create a nexus of supply and demand information, exchanges (where transactions physically take place), and incentives for communities to employ their social networks for the benefit of the community as well as interested individuals. Employing social media by communities, and incentivizing the communities to use it, creates revenues for the vendors, discounts for the individuals, and incentives for the community. In doing so, powerful incentives for people to act in concert with each other are created, as are revenues streams through the use of social media. It is through this action of specific communities engaging their members that value can be derived and measured through social media. The exchange monetizes social action, and can measure the results and degree of influence of social interaction.

In summary, systems configured in accordance with embodiments of the present invention are characterized by some or all of the following:
demand and supply portals for communities to identify their members' wishes, need and desires, and a platform for suppliers or vendors to respond to those requests;
a bid system, through which a community can request competitive bids for the goods and services their members wish to acquire and can negotiate such purchases with more than one bidder;
a monetary exchange where a transaction can be consummated;
an incentive program wherein the community is rewarded for enticing their members to participate in purchasing the goods or services they have sought (this may be in the form of discounted coupons or gift cards, or purchases of specific goods or services); and
the methods to create, predict, and value social networks and the ability to measure the degree to which information and demand spreads through a network.

Traditional social media advertising methods fail for several reasons. For example, although communities are formed and communicate with each other in increasingly sophisticated ways, including via social networking platforms (SNP) such as Facebook™, LinkedIn™, Twitter™, such artifices do not necessarily yield truly valuable information about the individual. While some (indeed, many) people create networks through SNPs, others have completely disconnected from SNPs or “hidden” themselves from all but only their closest of friends. Consequently, many members of an individual's strongest personal network(s) may not be included in a “Friend” or other list of contacts, but rather be identified only on a list associated with a personal phone or messaging or other communication appliance. Additionally, people may simultaneously belong to numerous communities, and may transition from one to another at will and within seconds. Individuals may even participate in and be engaged with more than one such community at the same time (sometimes through different means and/or modes of communication). Traditional social media advertising methods do not account for such behaviors.

Compounding these failures, traditional social media advertising (or, more broadly, Internet advertising in general) attempts to guess a person's interest by keystrokes in a browser, items posted, comments made, or items “liked” on a SNP, etc. However, by the time someone posts an indication of affinity toward a particular preference, it may be after the fact of having purchased or consumed that good or service. Their preferences could be changed, their need or desire already satiated. Traditional advertising using social media is therefore, at best, a post-hoc reaction to what was once of interest to someone.

In contrast, the present CIE discovers a person's and community's future interests by engaging the consumer and community in advance of a (purchasing) decision, and then attempts to influence spending patterns by using the community to affect individual outcomes before transactions take place. This may be manifest not only through the sale of a particular product, but also through point of sale (“POS”) discounts, or the sale of discounted store credits germane to consumers' future demands.

For purposes of the present invention, communities may be considered an aggregation of any two or more individuals with some form of a connection, or even an individual acting on preferences that engages at least one additional person. Super communities are larger communities, which have influence over members of multiple communities. A micro-community may be regarded as any member of a group through any means of communication or connection in which the individual has the greatest influence, and not the collective group.

Communities may be physical, such as in the case of a town's residents, a church congregation, club members, workplace colleagues, conference attendees, sorority members, etc. Super communities may be collections of communities, such as often occurs in schools and universities, churches or other national organizations with local chapters, or any of a plurality of organizations meeting similar characteristics of influence.

Communities may also be virtual in nature. Like their physical counterparts, virtual communities exhibit characteristics of influence but are not typified by actual, physical boundaries. Instead of a geographical or physical boundary defining the group, the group is defined by one or more common characteristics, ideas, ethos, or preferences.

Using the present CIE, any or all of the aforementioned groups can purchase discounted store credits or negotiate specific terms with a vendor of choice. Super communities, communities, micro-communities, and individuals can identify vendors who fit their specific needs. In one example, this operates much like buying a gift card, or using prepaid debit card, redeemable at a predetermined value, while purchased for a discounted value. The discount is pre-negotiated with the vender by either a community representative or by the CIE provider. Should the community engage its members in realigning their spending to benefit the vendor, the community may earn incentive points, commissions, or donations (depending on the needs of the community and its particular goals and legal status). In another example, the community may negotiate a larger incentive earned by and paid to the community in lieu of the discount to the individual. The balance between the level of discount to the individual, and the incentive earned by the community is imbedded in the process. This is determined through negotiations with the vendor, as well as input by individuals with their respective community.

Communities often hold sway with their members, as might a super community. However, the strongest ties and often the strongest spheres of influence are within the micro-community. That said, micro-communities are rarely organized, nor would they have much spending or pricing power. Working with communities to define their needs or wants leads to a more productive group buying exchange. Communities engaging their members, and, in turn, those members engaging their personal micro-communities, increase the likelihood of success in any particular transaction facilitated through the CIE. The community consequently gains a larger success incentive, helping it achieve its own success goals. Individuals who are engaged in the community have a vested interest in seeing the community be successful. Incentivizing the community still maximizes an individual self-interest because the community can better meet the individual's preferences, through an expression of their own preferences and increasing the individual's purchasing power. The success incentive for the community is fully transparent to each individual buyer and seller, so that there is no “hidden” agenda or fee. Each participant is a willing participant with a vested interest in the success of the promotion and consummation of sales.

Some vendors or communities may choose to use an “up front” purchase commitment by the individual, instead of the POS method mentioned in (0009). This includes the purchase of a (presumably discounted) store credit. After the purchase of the credit, the buyer is able to use the credit toward the purchase of any item offered by the vendor. We use the term “nod” meaning affirmative, acknowledgement, sign, or signal that the individual will now be a consumer at the vendor. The nod also signals support for the purchaser's community. Vendors may put certain restrictions on the use of the credits or POS purchases, but they must be disclosed prior to any sale being consummated generally displayed on the CIE website. While the consumer may choose not to redeem the credit him or herself, the purchaser, after consummation of the nod transaction, the purchaser has an economic interest to purchase something from the vendor, as the consumer has paid for the nod. Indeed, the nod represents a tangible economic interest redeemable for a future purchase. Pricing of the credits can also encourage recidivism of the customer. Partially unredeemed credits, or expenditures greater than the face value of the credit encourage either return visits or demonstrates increased spending at the vendor. Credits are not necessarily intended to be for the purchase of any specific product for sale by the vendor, but as a price of acquisition of a customer enticing them to buy something from the vendor. For the purchaser, the nod is an affirmation of his/her support of an associated community.

The community may choose to aggregate their members to create a certain “event” or viral event; consumers may pay for nods, or use the POS payment methods. A portion of the payment goes to the vendor, a transaction fee is paid back to the CIE provider, and an additional transaction fee is rebated to a sponsoring community. Vendors may associate a specific good or service with a nod for the purpose of advertisement, but nods are not necessarily tied to a good or service.

By tapping the power of the community, which in turns engages their micro-communities, spending patterns may be realigned with proper incentives. This incentive does not rely upon any particular means of communication among members of a community, but relies on the natural communication channels people have with their friends and colleagues. It does rely on the economic incentives presented to both the individual, acting in their own best interest, with that of the civic-minded community member who will also act in the best interest of the community.

Communities may create an urgency to make a purchase for an event or physical gathering. Individuals may choose to give or donate their store credits to another individual as they choose, much like a gift card. In any case, the vender has a higher likelihood that someone will redeem the credit by capturing and acquiring a customer. As communities and individuals have input into the types of goods and services they seek by advertising in the CIE, vendors meeting these demands have a high likelihood of influencing spending patterns by offering discounts to communities incentivizing them to use their services or purchase their goods. This method incentivizes not only individuals and micro-communities, but also incentivizes communities and super communities to engage their members to increase their individual and collective purchasing powers, as well as collect incentive fees for the benefit of the community.

The CIE includes a portal, which may be used in conjunction with any other portals, to create an exchange between community members and vendors. In addition, communities or super communities may sponsor versions of a CIE that cater more directly to the needs of their respective member communities. While a traditional exchange exists to exchange cash for a specific good or service, the CIE focuses on customer acquisition, not necessarily means for consummating an immediate sale of a specific product or service.

The CIE portal may include one or more general news and information portals as well as individual user dashboards, each unique to a given user and the constituency he/she represents. Some individuals may have more access to controls on the dashboard pursuant to the roles each play in a given community. Portals and/or individual user dashboards may be open and accessible or may be protected against unauthorized use and/or viewing through the use of common security mechanisms such as user-names and passwords, digital certificates, or other means. In one embodiment, the various portals that make up a CIE portal include some or all of the following:
1. General news and information.
2. Geographically centered news and information.
3. Super community news and information (created specifically for certain super communities).
4. Super community administration and information.
5. Community administration and information portal.
6. Individual user portal(s).
7. CIE provider's administration portal.
8. Vendor administration's and information portal.

General News and Information: The CIE provider may include general news and information portals that target communities or community segments. The news and information portals may be designed much like a traditional newspaper, with various sections for politics, business, life-style, education and other topics. These portals may or may not be aggregated with other portals and are intended to facilitate distribution of content contributed or sponsored by interested parties. For example, vendors may subscribe to submit newsworthy articles relevant to various communities to inform and entice communities to sponsor their promotion. Readers self-identify as to their interests by reading the news and information relevant or interesting to them and may comment and enter into interactive discussions regarding various items.

Geographically centered news and information: Similar to the general news and information portal, this may comprise one or more portals containing news and information with significant emphasis on local events and interests relevant to the community. The community may have significant editorial input on their news portal. Communities may also have sponsored content articles from vendors. In conjunction with these articles, the vendor may also offer a discounted store credit, promotion or gift card. Should the community wish to sponsor a particular promotion, that community may receive incentives to do so. Any interested person can choose to access these discounts by logging into the exchange and purchasing the discounted store credit or gift card, or visit the store location and use a POS payment method. Discounts are available to any person whether he/she is a member of a community or not. Only when a community chooses to sponsor a promotion will it receive an incentive for the promotion. When a community sponsors a promotion, it publishes the information to its members, who in turn use their social networks to relay the information to others. Rules of the exchange may require communities to disclose rebates or fees which the community receives for each person who participates in the promotion.

Portals, or certain promotions displayed for a community, may be closed so that only members of a community have access to information posted at the portal. For example, communities may offer closed promotions for their members so that unwelcome/unwanted individuals do not arrive uninvited to events. Consider, for example, a high school prom or similar event. The high school promoting the event (and negotiating discounts with providers, etc.) will not want persons other than the students (and perhaps family members of the students) to have access to information (and discount opportunities) concerning the prom. Hence, only members of the high school community will receive information concerning the event (and discounts) via the associated portal, which may be secured through a user name/password or other means.

Super community news and information: super communities are those formalized communities that have numerous communities over which they have significant influence, sway, or governance. A super community may be a school, church, or synagogue, a national organization with local chapters, and other such entities, for example. The super communities, together with their smaller communities, create news and information, as well as significant economic activity to warrant the creation of a news and information site for their own members. They may have significant editorial oversight. Certain promotions may be made available exclusively for their own members, due to the nature of the community.

Super Community administration and information portal: large super communities may sponsor an exchange with their respective members and communities. Super community portals have a view of both their participating communities individually, as well as an overview of all activity aggregated. Administrative portals include: a calendar of events for promotions being sponsored, displays of available promotional activities, management tools for controlling content published to the news and information portals, functionality for adding/removing, accepting/rejecting, or clarifying items to the “demand list”, event progress, funds generated and other relevant material for managing the exchange.

Community administration and information portal: similar in function to a super community portal, but without a hierarchy of other communities, and no aggregation, this portal includes: a calendar of events for promotions being sponsored, displays of available promotional activities, management tools for controlling content published to the news and information portal, functionality for adding/removing, accepting/rejecting, or clarifying items to the “demand list”, event progress, funds generated and other relevant material for managing the exchange.

Individual user portals: Individual portals provide a secure payment module, and accounting of any outstanding or unused credits or gift cards. Individuals can browse through promotions and access them, submit articles to the news and information portals, submit indications of interest on behalf of communities, and generally manage their accounts (or add communities to which they belong or wish to support and follow), and apply for special affinity POS cards or access mobile applications for payment or information

CIE provider's administration portal: the administration portal permits the CIE provider visibility into and access to all functionality and accounts of the CIE for quality assurance, technical enhancements, permissioning access for other users, setting up user profiles, support and further innovation.

Vendor's administration and information portal: the vendor portal allows for management of the activity between a vendor and the CIE. Vendors may create new profiles, contract for services, submit articles or information for publication, manage their receipts and outstanding credits, access a calendar of events in their area of interest or geography (as may be appropriate), submit bids for consideration, add items to a “supply list”, receive or create reports on usage and billing information, and communicate with potential sponsoring communities.

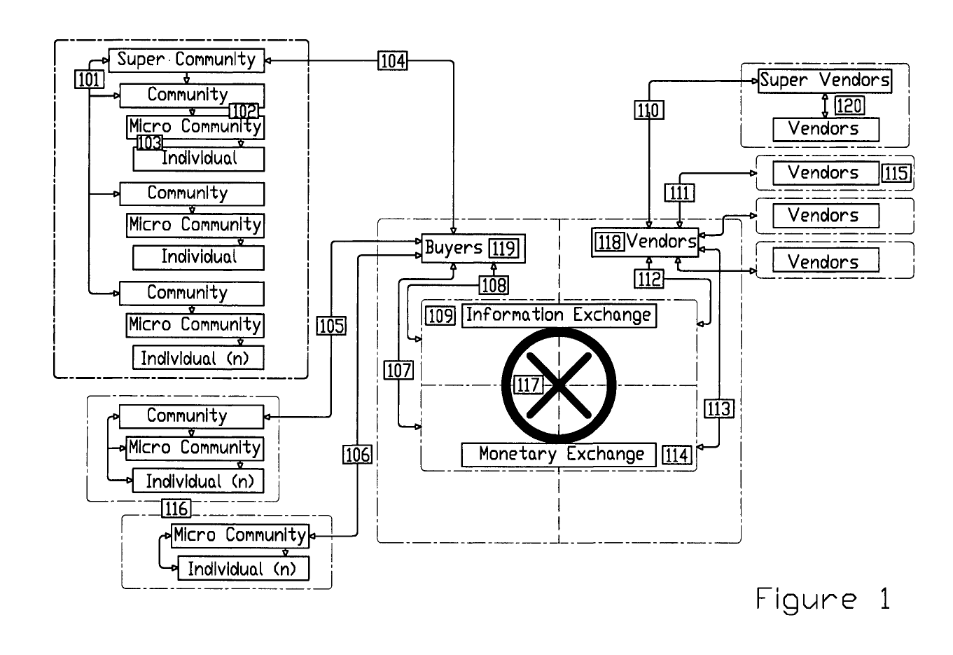

Turning now to FIG. 1 an overview of the CIE 117 and portal system is shown. As indicated above and shown in the illustration, a super community can be made up of various communities, micro-communities, and individuals. Noted by the double arrows, communication and influence can be bi-directional. Reference number 101 shows the communication between the super community and its various communities. Reference numbers 102 and 103 show where the communication and influence flows to the micro-communities and individuals. Aggregation through the communities and super communities grows the overall purchasing power of this entity.

Super communities, communities and micro-communities may exit in any number (n) and can be of different sizes and characteristics. Reference numbers 116 and 118 highlight examples of such entities. Information and ideas flow from each super community, community and/or micro-community to respective portals of the CIE 117. Reference numbers 104, 105 and 106 highlight this feature. The arrows between the various super communities, communities and micro-communities and their respective portals are bi-directional to highlight the fact that the information exchange is bi-directional in nature. In this illustration all communities are represented by a single buyer portal 119, however, this is intended to represent the aggregation of demand that exists in the various super communities, communities and micro-communities, and should not be regarded in a literal sense (i.e., as a single buyer). Notice that in addition to having access to the information exchange 109 via communication path 108, each super community, community and/or micro-community also has access to a monetary exchange 114 though communication path 107.

In a similar fashion, vendors have access to the CIE 117 and may be aggregated (see 120) as super vendors or may participate as individual vendors 115. The interests of all participating vendors may be aggregated via a vendor portal 118, and participated via bi-directional communication paths 110, 111. Supply information flows to/from the information exchange 109 and monetary exchange 114 through the vendor portal 118. Each individual vendor has access to the portal. Through this portal the supply inventory is available to the informational exchange. Here supply and demand can function in a market setting.

If the demand is met by supply or supply is met by demand, the members of the individual communities and the vendors can access the monetary exchange. From the community portal individuals using their own unique account can access the monetary exchange. Likewise, vendors with their unique accounts can access the monetary exchange from the vendor portal. Through the monetary exchange, money from the individuals may be exchanged for credit, gift cards, rewards, and goods or services of the respective vendor.

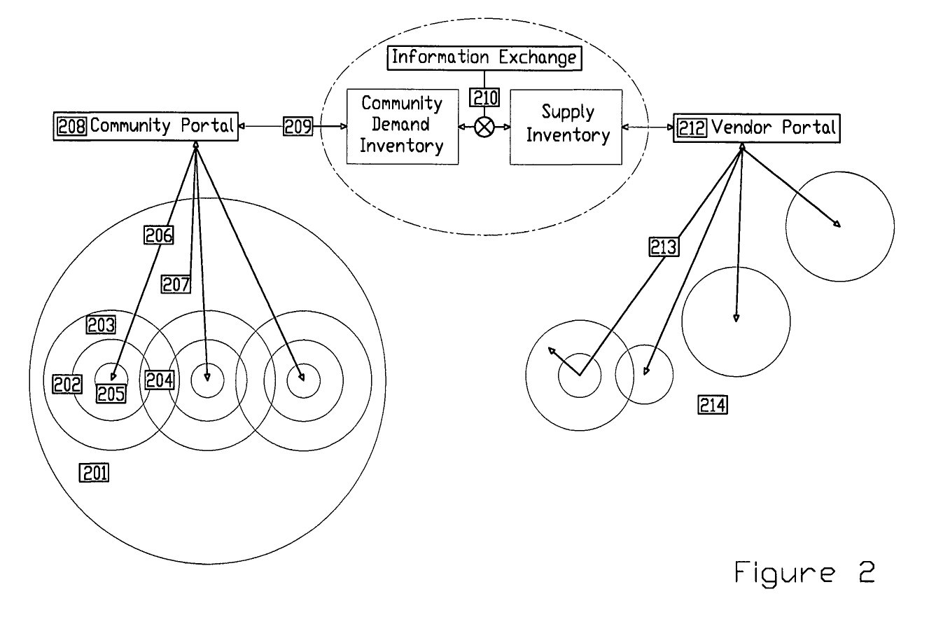

FIG. 2 illustrates the aggregation of community and influence and demonstrates the aggregation of individuals in communities, overlap and movement from community to community, and how influence and purchasing power is achieved through a portal into the exchange. In this diagram there are three example communities 201, but this is merely for purposes of illustration and any number of communities (including super communities and micro-communities may participate). Each community has what one may consider a sphere of strongest influence 205, a sphere of strong influence 202 and a sphere of weak influence 203. The illustration is intended to represent different collections of members within (and perhaps outside of) the community in terms of the influence which the community has over them at a given point in time (and perhaps with respect to a particular interest—although in some cases the community may be defined by an interest and so this characteristic would already be accounted for). Community members may be members of more than one community at one point in time. Communities may have overlapping influence 204 as well. A super community 207 encompasses multiple communities within its sphere of influence.

When information is gathered it is sent to the community portal in a normalized fashion at 206. Influence can flow or be channeled by any means, method, or path to the portal 208. The super community can influence its communities, micro-communities, and individuals using its various levels of influence and connections. The portal allows the communities to enter the exchange 210 with aggregated purchasing power via a common access point 209.

Also illustrated is a vendor portal 212, which is the aggregation point for product and/or service offerings (e.g., store credit, gift cards, rewards, or merchandise) to the exchange. Just like communities, vendors have various make-ups, supply overlap, and offerings (illustrated generally at 214 and communicatively coupled to the vendor portal via path(s) 213). Through the community portal and vendor portal the aggregate demand inventory meets the supply inventory. Once the demand finds the supply or the supply finds the demand, each portal can leverage its connections to influence its respective networks.

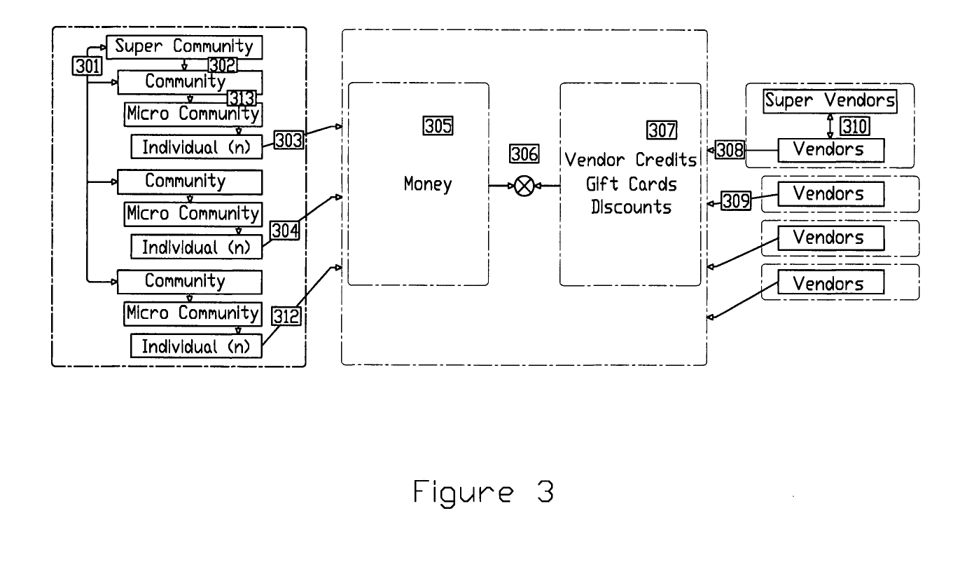

FIG. 3 illustrates the inflow of funds, store credit, gift cards, or merchandise. The influence 301 of the super community on its communities, micro-communities, and individuals flows through points 302 and 313. Acting on influence exercised through their communities, individuals make transactions at 303, 304, and 312.

Similar to communities, vendors can be influenced 310 by super vendors (e.g., communities of vendors, such as trade organizations and the like). However, only individual vendors effect transactions at 308 and 309.

At the monetary exchange 306, money or other consideration 305 from the individuals is exchanged for store credit, rewards, gift cards, or merchandise 307.

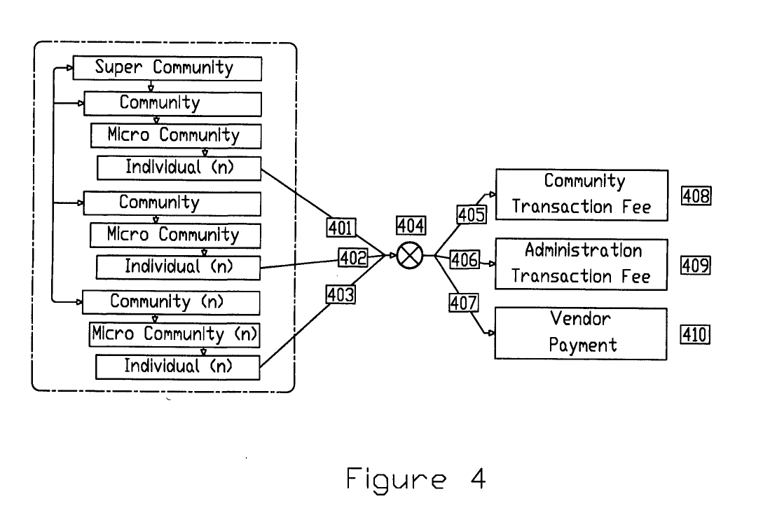

FIG. 4 illustrates the outflow of funds from the monetary exchange 404. CIE rules may require all parties to disclose all distribution of funds prior to participation. Funds arrive at monetary exchange 404 from individuals as shown at 401, 402, and 403. The exchange of store credit, rewards, and/or gift cards has already taken place as explained above with reference to FIG. 3. As the transaction occurred within the nexus of the monetary exchange, the funds collected must be distributed 405, 406, 407 back to the participants. The community receives a community transaction fee 408 for every transaction, which fee represents the community's incentive to entice its members to purchase the product (credit or merchandise). An administration transaction fee 409 is taken by the CIE operator to cover the cost of operating the exchange. Finally, the vendor receives payments 410 in connection with each transaction into a predetermined account. All transactions are fulfilled electronically in real time and the distribution of funds made by the CIE administrator occurs by agreement after transactions are completed between the individual/community and the vendor.

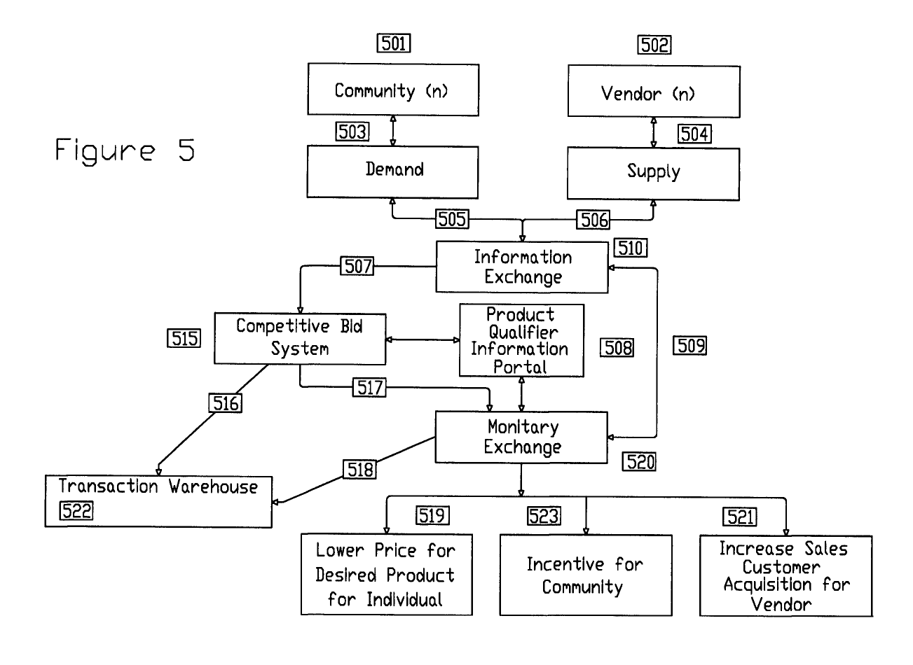

FIG. 5 illustrates one example of a process of publishing supply or demand, which can be initiated either by a community 501 or a vendor 502. The community creates the demand inventory 503 and the vendor creates the supply inventory 504 through the portal system. Each portal communicates 505, 506 with the information exchange 510. After the information is exchanged, vendors and communities/individuals can choose between two paths: either a competitive bid system via path 507 or a direct transaction via the monetary exchange through path 509. At a qualifier information portal 508, communities may make offers to vendors and bid for price and quality. For example if a group of people are going out to dinner, they can select restaurant vendors within the CIE system to see which restaurant can make the best offer. The winning restaurant need not necessarily be the one offering the lowest price, as selection may be made according to a vector of features, including but not limited to price. The winning restaurant will thus be the one making the best offer as seen from the perspective of the community (in this case, the group of diners). After the exchange identifies a match, the community(ies) and the vendor(s) move to the monetary exchange through path 517.

Propriety information may be collected at the informational exchange 510, the monetary exchange 520 and the competitive bid (auction) 515 and sent 518 to a transaction warehouse 522 for future reference and further processing. The monetary exchange may yield discounted prices for products (credit, reward, merchandise) for individuals 519 due to community purchasing power and monetary incentives for communities 523. Finally, the CIE lowers the customer acquisition costs and increases sales for the vendor 521.

Having thus described the transaction flow facilitated by the CIE, we turn now to various features and aspects of such transactions. As indicated above, communities, super communities and micro-communities can register through an electronic portal. In so doing, the communities provide demographic information, member contact information, and geographic and proprietary information, and may designate affiliate communities. Upon successful registration, the CIE provides a unique identifying code to each registered community. Individuals may view a public CIE barter transaction with out registering, but must register through the electronic portal to purchase nods/complete transactions. When registering, individuals provide demographic, geographic and proprietary information (e.g., banking and credit processing information), and may designate affiliate communities. The CIE provides a unique identifying code to each registered individual. Vendors also register through an electronic portal by providing demographic, geographic and proprietary information, and may designate affiliate communities. The CIE provides a unique identifying code to each registered vendor.

The CIE can link unique identifying numbers for communities and affiliates. This allows for tracking of incentive allocations, either shared or distributed centrally. The CIE also establishes sales members, who may be either designated individuals within a community who have authority to negotiate barter transactions and terms with vendors, or direct representatives of the CIE.

Using the CIE, multiple communities may work together as or under a super community. The CIE and individual communities may designate a specific sponsoring community for the purpose of identifying the recipient of available incentives as a result of the sale of “nods” for a specific barter transaction or POS transactions. Sales member(s) who are agents of CIE, sponsoring communities, or vendors may initiate “barter” or deal negotiations through any means, including but not limited to the electronic portal system. Barter transaction terms may be further negotiated between parties through electronic means or in some cases face- to-face. The terms of the barter transaction and all parties are registered with the CIE and the CIE administers, verifies and approves the terms of the barter and creates a unique identifying “nod code” for the sale of each barter. As indicated above, nods are best viewed as an affirmative gesture, for example a discounted gift card, POS transaction or store credit with a specific vendor. Prepaid transactions represent a partial purchase and commitment for future subsequent purchase, and immediate cash flow to the vendor. POS transactions are complete transactions paid at point of sale. POS transactions are identified with a similar nod code for tracking, management and accounting purposes.

Sales members and sponsoring communities then promote the respective barter and sell nods or encourage POS transactions. The CIE posts the terms of the barter and makes it available to appropriate communities via any electronic channel including CIE portals, websites, mobile devices, social media, tablets, print media, television, etc. Posting of barter transactions can be in the form of sponsored content, news articles, coupons, or any other means of advertisements or media linked to the CIE. However, all barter transactions will be posted on CIE portal.

Community members may promote through their own contacts the purchase of nods and POS transactions benefiting their own community. The CIE provides an incentive to the community when individual nods or POS transactions designating that specific community are purchased. The purchase of a nod or POS transaction with a community designation becomes a revenue stream for communities sponsoring barter transactions.

If there are multiple sponsoring communities for an individual barter transaction, individuals will be able to designate which community or affiliate community they wish to support. Each purchased “nod” is attached to the unique individual code and community code. POS transactions will be credited to the community designated on the individual's website, or via other means, and in absence of a designation, to the community sponsoring the promotion. The aforementioned codes are compiled to form a nod transaction code, which is used to identify all parties involved in the transaction in a unified number. Only no transaction codes can be processed to move money or funds for nods, or make appropriate incentive payments for POS transactions.

The CIE processes and tracks the flow of money to and from appropriate vendors. Communicating through an electronic portal, the CIE passes the unique identifier of the nod to the appropriate vendor and tracks used and unused nods. To redeem a nod, an individual provides a unique nod code to the vendor and the vender verifies same through the CIE portal. The CIE will provide information such as the remaining balance and whether or not the transaction was successful. Vendors report each used nod through the portal to prevent double usage or fraud. Vendors may also input additional transactional information into the CIE for tracking. Individuals can monitor their nods through their respective electronic portal. When POS transactions are made at the vendor by the individual, CIE receives transaction data from the participating card sponsor to create the CIE transaction code. This information is then used to create reports, vendor billing for community rebates and other administrative functions.

The CIE tracks rebates for each community that sponsors a barter and remits incentives to the community on an agreed upon schedule. The CIE tracks and measures the performance of each barter transaction, success of each community in motivating their members to participate in the barter transaction through individual “nod” purchases and POS transactions. Non-identifiable collective information regarding the CIE (and its activities) may be analyzed and sold. Nods can be donated or transferred to any other individual in the CIE. Certain time or other restrictions may apply as imposed by vendors.

Accordingly, one embodiment of a method for creating and the use of a community-incentivized exchange (CIE) has been described. In various instantiations, the aforementioned methods and the CIE itself may be implemented with the aid of computer processor-based hardware executing computer-readable processes or methods (a.k.a. software, programs or routines) that may be rendered in any computer language. Accordingly, it should be appreciated that some portions of the foregoing description were intended as discussions of algorithms and symbolic representations of operations on data within a computer memory. These algorithmic descriptions and representations are the means used by those skilled in the computer science arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared and otherwise manipulated. Unless specifically stated otherwise, it will be appreciated that throughout the description of the present invention, use of terms such as “processing”, “computing”, “calculating”, “determining”, “displaying” or the like, refer to the action and processes of an appropriately programmed computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention can be implemented with an apparatus to perform the operations described herein. This apparatus may be specially constructed for the required purposes, or it may comprise a computer system that is selectively activated or reconfigured by a computer program that it executes and which is stored on one or more computer-readable storage mediums accessible to processing, elements of the computer system. For example, such a computer program may be stored in a non-transitory computer readable storage medium, such as, but not limited to, any type of disk including floppy disks, optical disks, compact disk read only memories (CD-ROMs), and magnetic-optical disks, read-only memories (ROMs), flash drives, random access memories (RAMs), erasable programmable read only memories (EPROMs), electrically erasable programmable read only memories (EEPROMs), flash memories, other forms of magnetic or optical storage media, or any type of media suitable for storing electronic instructions, and each accessible to a computer processor, e.g., by way of a system bus or other communication means. The invention can also be practiced in distributed computing environments where tasks are performed by computer processing devices that are remote to one another, either physically and/or logically, and are linked through one or more communications networks.

In one embodiment, the physical transition is not stored. Rather, a data feed is received from a transactional processor to confirm an individual spent X amount at a vendor at a particular time. This may be implemented as an XML data feed from a plural transactional processor (VISA, AMEX, etc.). Next, data is matched (and may be stored) so that the reward set by the vendor can be attributed to the data fee from the transactional processor.

The present invention is usable with currently available computer systems, servers and the like. Such a computer system will generally include a bus or other communication mechanism for communicating information, and a processor coupled with the bus for processing information. The computer system will also include a main memory, such as a RAM or other dynamic storage device, coupled to the bus for storing information and instructions to be executed by the processor and for storing temporary variables or other intermediate information during execution of instructions to be executed by the processor. The computer system further may also include a ROM or other static storage device coupled to the bus for storing static information and instructions for the processor. A long-term storage device, such as a hard disk or solid state storage device, may also be provided and coupled to the bus for storing information and instructions. Other elements, such as displays, cursor-control devices, alphanumeric input devices, etc. may be provided to facilitate human operation of or interaction with the computer system. So too may communication interfaces, such as wired and/or wireless network interfaces, be provided to allow for communications between the subject computer system and other computer systems (e.g., via one or more computer networks or networks of networks).

The various methods discussed herein may be instantiated as computer-readable instructions on one or more non-transitory computer-readable program products, such as disks, drives, solid-state media, and the like. Such methods encompass the connecting of social communities in order to align (or realign) the spending patterns of community members (e.g., networks of individuals) in a way that benefits the communities. Such benefits are preferably, though not necessarily, monetary in nature. This goal is achieved through the community using its influence over its members to aggregate demand for a product or service “sponsored” by the community in order to entice members of the community to purchase the sponsored product/service from a designated vendor or vendors. The transactions are processed through a CIE, which can also operate to promote the sponsorship and inform the community members of same, so that appropriate credit can be provided back to the community. By creating aggregated demand in the form of its membership, vendors are incented to offer benefits for the community. The community is thus incented to organize and influence its members (to obtain these benefits), and the individual members of the community are incented to make the purchases (inasmuch as the members already have existing demands for the products/services being offered as recognized through their common community bonds). Instead of vendors trying to guess what advertisements or enticements will lead to increased sales, the communities are driven to do the work of organizing the individual consumers that comprise its membership along lines of common (purchasing) interests.

Of course, it should be understood that the order of the acts of the algorithms discussed herein may be accomplished in different order depending on the preferences of those skilled in the art, and such acts may be accomplished as software. Furthermore, though the invention has been described with respect to a specific preferred embodiment, many variations and modifications will become apparent to those skilled in the art upon reading the present application. Specifically, the invention may be altered, in ways readily apparent to those of ordinary skill in the art upon reading the present disclosure. It is therefore the intention that the appended claims and their equivalents be interpreted as broadly as possible in view of the prior art to include all such variations and modifications.

What is claimed is:

1. A community-incentivize exchange (CIE), comprising:
at least one computer systems configured to permit aggregation of purchasing power of social community members along aligned interests;
the computer system configured to facilitate purchases of desired nods or POS transactions from one or more vendors willing to exchange the nods or consummate POS transactions for consideration from the members; and
the computer system configured to return compensation to the social community in exchange for incentivizing the members to effect such purchases.

2. A computer-implemented system of managing a multi-tiered exchange, comprising:
a community having members (“community members”);
facilitating alignment of spending patterns of the community members such that the community benefits by remuneration from at least one vendor in exchange for member purchases of nods or point-of-sale (“POS”) transactions offered by the at least one vendor via a computer-based exchange;
the exchanging having a first tier that includes an informational portal, identifying “demand information”, including at least a self-identified need within the community, and relaying the demand information to at least one vendor that has chosen to participate in the exchange by offering discounts or incentives to the community as a whole;
the exchange having a second tier that includes a competitive bid exchange where communities can request bids for more specific needs from multiple vendors; and
the exchange having a third tier that includes a monetary exchange whereby a purchasing commitment of funds by members in exchange for goods or services takes place takes place.

5. The system of claim 1 wherein the exchange occurs within a CIE.

6. The system of claim 1 wherein the exchange occurs within a Point of Sale system.

7. The system of claim 1 wherein the exchange occurs within a third party transactional processor.

3. A computer-implemented exchange configured to facilitate transactions between purchasing groups and vendors, comprising:
defining a purchasing group having members;
aggregating purchases of members of the purchasing group to define solicitations for purchase of one or more defined items;
completing transactions of members with at least one vendors that accepts the solicitations, and
distributing a portion of the transaction proceeds to an organization which collected the members together for purposes of completing the transaction.
